(19) United States
(12) Patent Application Publication
(10) Pub. No.: US 2002/0134213 A1
(43) Pub. Date: Sep. 26, 2002

(54) Substrate cutting system

(76) Inventors: Brian Causse, Phoenix, AZ (US); Paul Lemens, Scottsdale, AZ (US); Joseph Ellijio Velazquez, Gilbert, AZ (US)

Correspondence Address: PILLSBURY WINTHROP, LLP, P.O. BOX 10500, MCLEAN, VA, 22102, US

(21) Appl. No.: 09/814,118

(22) Filed: Mar. 22, 2001

(51) Int. Cl. B26D 5/08; B26D 1/45; B26D 3/10

(52) U.S. Cl. 83/565; 83/698.21; 83/743; 83/382; 83/454

(57) ABSTRACT

A substrate cutting system for performing a substrate cutting operation wherein a substrate portion is cut from a selected substrate comprises a cutter guide and a substrate cutter. The cutter and the cutter guide enable the substrate cutting operation to be performed by engaging a substrate engaging surface of the cutter guide with the selected substrate, penetrating the selected substrate with a blade of the cutter, and then moving the cutter with guidable and guiding surfaces of the cutter and cutter guide, respectively, engaged with one another such that the guiding and guidable surfaces cooperate to guide the cutter so that the cutting edge of the blade cuts the selected substrate along a cutting path generally similar to the guiding surface to cut the substrate portion from the selected substrate and provide the substrate portion with a peripheral geometric shape determined by the cutting path.

### FIELD OF THE INVENTION

The present invention relates to a substrate cutting system for performing a substrate cutting operation wherein a substrate portion is cut from a selected substrate.

### BACKGROUND AND SUMMARY OF THE INVENTION

Substrate cutting systems of the type herein contemplated are utilized to trim photographs or other substrates to a desired configuration. For example, with photographs, users desire the photographs to be of a certain size in order to fit them in a standard frame or album. Known cutting systems typically comprise a guide that is adapted to mount a cutter having a blade attached thereto. The guide and cutter are positioned on the paper and the cutter is moveable along the guide so as to cut the photograph to a predetermined size.

Examples of cutting systems are disclosed in British Patent Publication Nos. 14,836 and 20,694. However, these cutting systems have several shortcomings.

One shortcoming with these known cutting systems is that the hand grip portion of the cutter is fixedly mounted so the user may have to change hand positioning as the cutter is moved about the guide. Specifically, as the cutter is moved around the guide, the user's hand and wrist become positioned at an angle to one another. Such positioning formulates stress at the wrist, which becomes uncomfortable to the user as the angle increases. The user must change his or her hand positioning in order to relieve this stress and continue moving the cutter about the track.

One aspect of the present invention overcomes this shortcoming by providing a substrate cutting system for performing a substrate cutting operation wherein a substrate portion is cut from a selected substrate. The system comprises a cutter guide and a substrate cutter. The cutter guide has a substrate engaging surface engageable with the selected substrate and a guiding surface. The substrate cutter comprises a base portion, a manually engageable hand grip portion configured to be manually grasped, a guidable surface provided on the base portion, and a substrate cutting blade. The guidable surface is engageable with the guiding surface of the cutter guide. The substrate cutting blade is configured to penetrate the selected substrate such that movement of the blade when penetrated cuts through the selected substrate. The cutter and the cutter guide are constructed and arranged to enable the substrate cutting operation to be performed by engaging the substrate engaging surface of the cutter guide with the selected substrate, penetrating the selected substrate with the cutting blade, and then moving the cutter with the guidable and guiding surfaces engaged with one another. The guiding and guidable surfaces cooperate to guide the cutter so that the cutting edge of the blade cuts the selected substrate along a cutting path generally similar to the guiding surface to cut the substrate portion from the selected substrate and provide the substrate portion with a peripheral geometric shape determined by the cutting path and thus similar to the guiding surface. The hand grip portion is rotatably mounted on the base portion such that the base portion rotates relative to the hand grip portion. The rotatable mounted hand grip portion allows a user's hand to remain in generally the same orientation with respect to the selected substrate as a change in direction of movement of the cutter occurs during movement of the cutter with the guidable and guiding surfaces engaged with one another as aforesaid.

Another problem with the systems disclosed in the patent documents is the manner in which the cutter is guided around the guide. For example, in the British Patent Publication 14,836, one embodiment has a ring-like band D with a rod F fixedly mounted thereto, the rod F adjustably mounting the cutting blade. The band D is mounted within a hole provide in the plate A, such that the band D may be rotated therein so as rotate the blade. In the British Patent Publication 20,694, one embodiment has runners e that are secured to the track c by clips i. The runners e operatively mount the cutting blade so that the runners may be moved about the track c to rotate the blade. Both examples have a cutter that is mounted to a guide, such that installation on and removal from the guide is difficult. This also makes it difficult to use the cutter with different size or shape guides. Moreover, the manner in which the cutter is mounted to the guide makes it difficult for the user to perform a cutting operation.

Another aspect of the present invention overcomes this shortcoming by providing a substrate cutting system for performing a substrate cutting operation wherein a substrate portion is cut from a selected substrate. The system comprises a cutter guide and a substrate cutter. The cutter guide has a substrate engaging surface engageable with the selected substrate and a groove providing an opposed pair of guiding surfaces on an interior thereof. The substrate cutter comprises a base portion, a guide structure extending from the base portion, and a substrate cutting blade. The guide structure is receivable in the groove of the cutter guide between the guiding surfaces with the guiding surfaces on opposing sides of the guide structure. The substrate cutting blade is configured to penetrate the selected substrate such that movement of the blade when penetrated cuts through the selected substrate. The cutter and the cutter guide are constructed and arranged to enable the substrate cutting operation to be performed by engaging the substrate engaging surface of the cutter guide with the selected substrate, penetrating the selected substrate with the cutting blade, and then moving the cutter with the guide structure received in the groove. The guiding surfaces and the guide structure cooperate to guide the cutter so that the blade cuts the selected substrate along a cutting path generally similar to the guiding surfaces to cut the substrate portion from the selected substrate and provide the substrate portion with a peripheral geometric shape determined by the cutting path and thus similar to the guiding surfaces. Preferably, the guiding surfaces are endless so as to provide a closed-loop cutting path.

Still another shortcoming with the prior cutting systems mentioned above is that the cutters have rigidly mounted blades, which tends to tear comers when cutting rectangular shapes. A rigidly mounted blade makes an abrupt change of direction at corners, which results in poor trimming at the comers.

Another aspect of the present invention overcomes this shortcoming by providing a substrate cutting system for performing a substrate cutting operation wherein a substrate portion is cut from a selected substrate. The system comprises a cutter guide and a substrate cutter. The cutter guide has a substrate engaging surface engageable with the selected substrate and a guiding surface. The substrate cutter comprises a base portion, a guidable surface provided on the base portion and engageable with the guiding surface of the cutter guide, and a substrate cutting blade having a cutting edge. The blade is configured to penetrate the selected substrate such that the cutting edge of the blade when penetrated cuts through the selected substrate as the cutter is moved. The cutter and the cutter guide are constructed and arranged to enable the substrate cutting operation to be performed by engaging the substrate engaging surface of the cutter guide with the selected substrate, penetrating the selected substrate with the cutting blade, and then moving the cutter with the guidable and guiding surfaces engaged with one another. The guiding and guidable surfaces cooperate to guide the cutter so that the cutting edge of the blade cuts the selected substrate along a cutting path generally similar to the guiding surface to cut the substrate portion from the selected substrate and provide the substrate portion with a peripheral geometric shape determined by the cutting path and thus similar to the guiding surface. The cutting blade is rotatably mounted on the base portion such that the blade rotates relative to the base portion so that the cutting edge of the blade remains generally aligned along the cutting path as a change in direction of movement of the cutter occurs during movement of the cutter with the guidable and guiding surfaces engaged with one another as aforesaid.

Yet another shortcoming with known cutting systems is that relative movement may occur between the cutter guide and the paper when performing a cutting operation. This relative movement causes inaccurate cuts to be performed. Specifically, relative movement between the cutter guide and the paper may cause the blade to cut out of line with the intended cutting path into a portion of the substrate which the user desired to leave intact.

Another aspect of the present invention overcomes this shortcoming by providing a substrate cutting system for performing a substrate cutting operation wherein a substrate portion is cut from a selected substrate. The system comprises a cutter guide and a substrate cutter. The cutter guide includes a body formed from a first material and providing a guiding surface. The cutter guide further includes a substrate engaging portion formed from a second material and providing a substrate engaging surface engageable with the selected substrate. The second material has a substantially higher coefficient of friction than the first material so as to inhibit slippage between the selected substrate and the substrate engaging surface. The substrate cutter comprises a base portion, a guidable surface provided on the base portion and engageable with the guiding surface of the cutter guide, and a substrate cutting blade. The blade is configured to penetrate the selected substrate such that the blade when penetrated cuts through the selected substrate as the cutter is moved. The cutter and the cutter guide are constructed and arranged to enable the substrate cutting operation to be performed by engaging the substrate engaging surface of the cutter guide with the selected substrate, penetrating the selected substrate with the cutting blade, and then moving the cutter with the guidable and guiding surfaces engaged with one another. The guiding and guidable surfaces cooperate to guide the cutter so that the cutting edge of the blade cuts the selected substrate along a cutting path generally similar to the guiding surface to cut the substrate portion from the selected substrate and provide the substrate portion with a peripheral geometric shape determined by the cutting path and thus similar to the guiding surface.

Yet another shortcoming is that the cutters have rigidly mounted blades. As a result, the blade has a specific depth of penetration. This specific depth may not be sufficient to cut through certain materials or a combination of materials stacked in a layered manner.

Yet another aspect of the present invention overcomes this shortcoming by providing a substrate cutting system for performing a substrate cutting operation wherein a substrate portion is cut from a selected substrate. The system comprises

a cutter guide and a substrate cutter. The cutter guide has a substrate engaging surface engageable with the selected substrate and a guiding surface. The substrate cutter comprises a base portion, a manually engageable hand grip portion configured to be manually grasped, a guidable surface provided on the base portion and engageable with the guiding surface of the cutter guide, and a substrate cutting blade. The blade is configured to penetrate the selected substrate such that movement of the blade when penetrated cuts through the selected substrate. The cutter and the cutter guide are constructed and arranged to enable the substrate cutting operation to be performed by engaging the substrate engaging surface of the cutter guide with the selected substrate, penetrating the selected substrate with the cutting blade, and then moving the cutter with the guidable and guiding surfaces engaged with one another. The guiding and guidable surfaces cooperate to guide the cutter so that the cutting edge of the blade cuts the selected substrate along a cutting path generally similar to the guiding surface to cut the substrate portion from the selected substrate and provide the substrate portion with a peripheral geometric shape determined by the cutting path and thus similar to the guiding surface. The blade is adjustable relative to the base portion so as to enable a depth of penetration of the blade with respect to the selected substrate.

Other objects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 is a perspective view of a preferred embodiment of the substrate cutting system in accordance with the principles of the present invention;

FIG. 2 is a side view of a substrate cutter of the substrate cutting system;

FIG. 3 is a perspective view of the bottom of the substrate cutter;

FIG. 4 is a cross-sectional view of a portion of the substrate cutting system illustrating the substrate cutter received in a cutter guide;

FIG. 5 is a cross-sectional view illustrating the rotatable mounting of the blade of the substrate cutter;

FIG. 6 is a side view of the substrate cutting system;

FIG. 7 is a side view of the substrate cutting system with the cutter guide shown in cross-section;

FIG. 8 is a cross-sectional view illustrating the groove provided in the cutter guide;

FIG. 9 is a perspective view illustrating the movement of the substrate cutter along the cutter guide;

FIG. 10 is a plan view illustrating a further embodiment of the cutter guide; and

FIG. 11 is a plan view illustrating a further embodiment of the cutter guide.

### DETAILED DESCRIPTION OF PREFERRED EMBODIMENTS

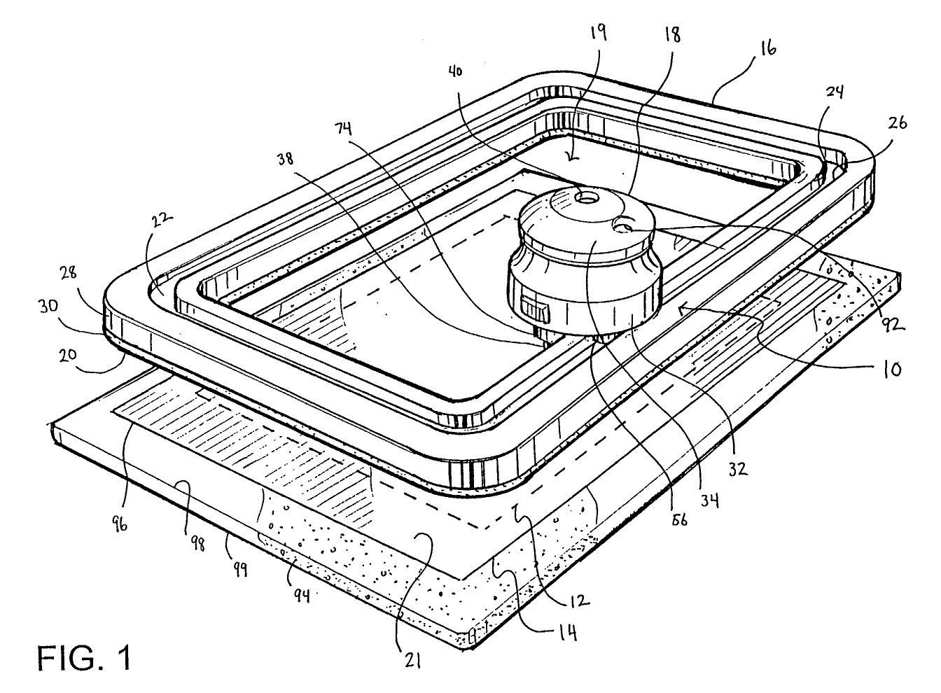

FIG. 1 shows a substrate cutting system 10 for performing a substrate cutting operation. In the substrate cutting operation, a substrate portion 12 is cut from a selected substrate 14. The selected substrate 14, for example, may be in the form of a sheet of paper having a portion with a digital photograph printed thereon, as is conventional with a computer printer. As the sheet of paper is generally 8 ½×11, the printed photo has to be trimmed in order to fit a standard size frame or album. Thus, the cutting system 10 is utilized to cut the portion on which the digital photo is printed from the sheet of paper to a predetermined size suitable for mounting in a picture frame or photo album.

The cutting system 10 comprises a cutter guide 16 and a substrate cutter 18.

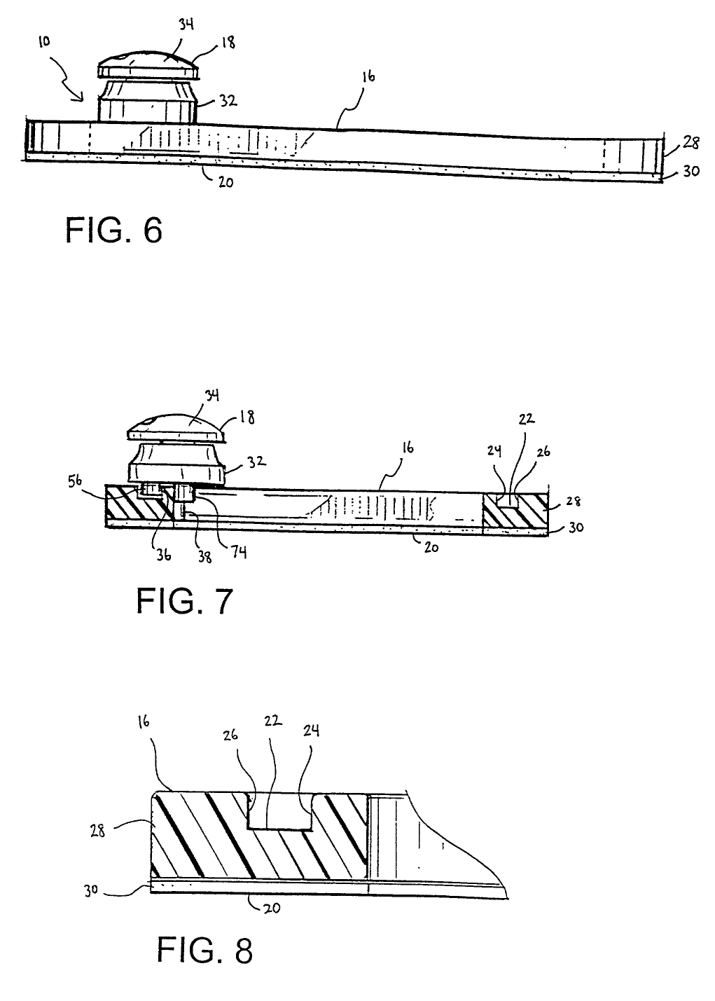

As illustrated in FIG. 1, the cutter guide 16 has a generally rectangular fixed shape that encloses an interior space 19. The cutter guide 16 includes a substrate engaging surface 20 engageable with an upper surface 21 of the selected substrate 14 and an endless groove 22 providing an opposed pair of endless guiding surfaces 24, 26 on an interior thereof, as shown in FIGS. 1, 4, and 6-9. The guiding surfaces 24, 26 are parallel to one another. The substrate engaging surface 20 and the guiding surfaces 24, 26 of the cutter guide 16 are generally perpendicular to one another.

More specifically, the cutter guide 16 is molded from plastic. The cutter guide 16 has a body 28 formed of a first material and a substrate engaging portion 30 formed of a second material providing the substrate engaging surface 20. The second material of the substrate engaging portion 30 has a substantially higher coefficient of friction than the first material so as to inhibit slippage between the upper surface 21 of the selected substrate 14 and the substrate engaging surface 20 during a cutting operation. The second material may be in the form of a foam, urethane, or any other high friction material that tends to prevent the cutter guide 16 from moving relative to the selected substrate 14. Alternatively, the substrate engaging surface 20 may be provided by the lower surfaces of a plurality of individual legs instead of one large surface.

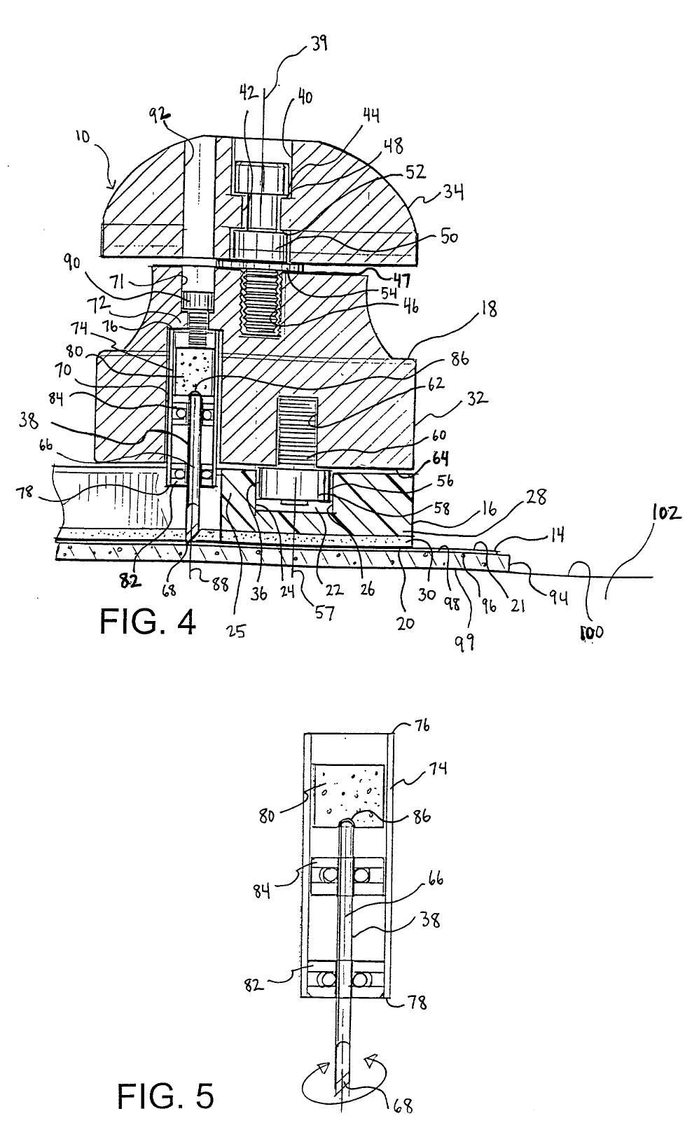

Referring to FIG. 4, the substrate cutter 18 comprises a base portion 32, a manually engageable hand grip portion 34 configured to be manually grasped, a guidable surface 36 provided on the base portion 32, and a substrate cutting blade 38.

The base portion 32 and the hand grip portion 34 are each molded from plastic. The hand grip portion 34 is rotatably mounted on the base portion 32 such that the base portion 32 rotates relative to the hand grip portion 34 about an axis 39. Specifically, the hand grip portion 34 has an axial bore 40 therethrough (see FIG. 4). An annular flange 42 extends radially inwardly from an interior surface of the bore 40. A fastener 44, such as a bolt, is inserted through the bore 40 and into a cooperating threaded opening 46 provided in an upper surface 47 of the base portion 32 such that the head of the fastener 44 is adjacent an upper surface 48 of the flange 42. The fastener 44 is further secured to the inner race of a ball bearing 50 secured within the bore 40 adjacent a lower surface 52 of the flange 42, so that the base portion 34 and the hand grip portion 34 may rotate relative to one another about the axis 39. An annular spacer 54, such as a washer, is positioned between the base portion 32 and the hand grip portion 34 about the fastener 44. The illustrated configuration of the rotatably mounted hand grip portion 34 provides generally the same grip for both left and right handed users, therefore applicable to all.

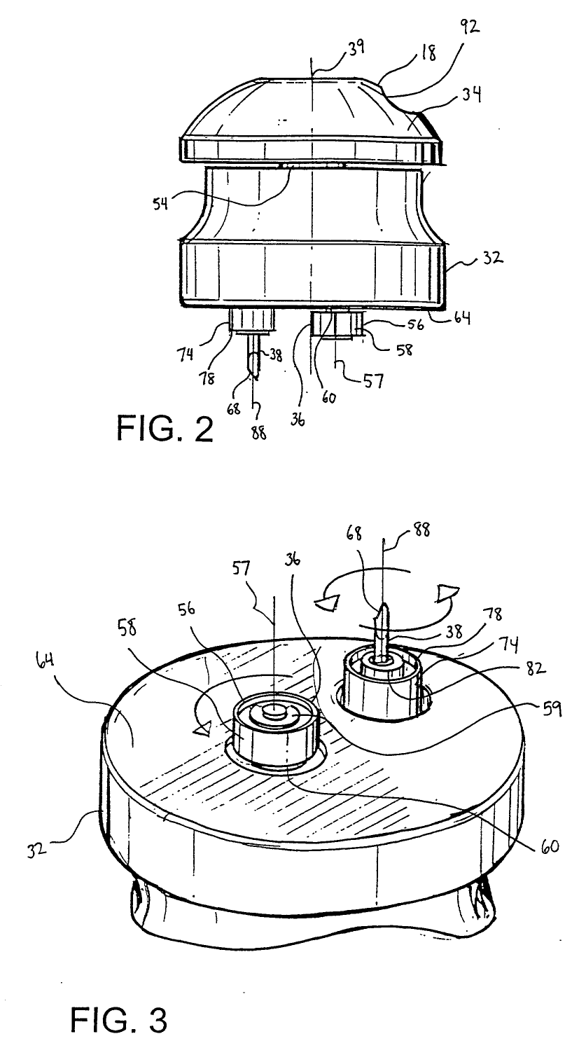

The guidable surface 36 is engageable with the guiding surfaces 24, 26 when the cutter 18 is mounted to the cutter guide 16. In the illustrated embodiment as shown in FIGS. 2-4 and 9, the cutter 18 comprises a guide structure, in the form of a single generally cylindrical projection 56, which extends from the base portion 32. The projection 56 provides the guidable surface 36. Specifically, the projection 56 comprises a ball bearing 58 rotatably mounted to the end of a threaded shaft 60 so as to be rotatable about an axis 57. The ball bearing 58 may be mounted to the end of the shaft 60 via a C-clip 59, as shown in FIG. 3. The threaded shaft 60 is secured within a threaded bore 62 provided in a lower surface 64 of the base portion 32 and axially offset from the axis 39. The ball bearing 58 of the projection 56 is receivable in the groove 22 of the cutter guide 16 between the endless guiding surfaces 24, 26 such that the guiding surfaces 24, 26 engage opposing sides of the ball bearing 58 and cooperate with the ball bearing 58 to guide the cutter 18 during movement thereof to cut the selected substrate 14. The use of the ball bearing 58 facilitates moving the cutter 18 around corners. However, the provision of a ball bearing assembly is not necessary.

FIGS. 4-5 show the substrate cutting blade 38, which includes an elongated tubular body 66 and a cutting edge 68. The blade 38 is configured to penetrate the selected substrate 14 such that the cutting edge 68 of the blade 38, when penetrated, cuts through the selected substrate 14 as the cutter 18 is moved. The cutting blade 38 is rotatably mounted on the base portion 32 such that the blade 38 rotates relative to the base portion 32.

Specifically, the base portion 32 includes a bore 70 in the lower surface 64 and a bore 71 in the upper surface 47 thereof. These bores 70, 71 are axially offset from the axis 39. The bores 70, 71 meet at an radially inwardly extending flange 72 positioned therebetween. An annular sleeve member 74 is secured within the bore 70 such that an upper surface 76 of the sleeve member 74 is adjacent the flange 72 and a lower surface 78 of the sleeve member 74 is spaced outwardly from the lower surface 64 of the base portion 32. A magnet 80 and a pair of ball bearings 82, 84 are securely positioned within the sleeve member 74 so as to removably and rotatably mount the blade 38. As illustrated in FIGS. 4-5, the tubular body 66 of the blade 38 extends through inner races of the ball bearings 82, 84 and is received within a recess 86 provided in the magnet 80. The blade 38 is constructed of a metal, such as steel, so that the magnet 80 secures the blade 38 from axial movement with respect to the base portion 32, but permits rotational movement about a rotational axis 88. The blade 38 is also easily removable for replacement.

The magnet 80 is adjustable within the sleeve member 74 in order to adjust the blade 38 engaged therewith. The blade 38 is adjustable in a depth setting direction relative to the base portion 32 so as to enable a depth of penetration of the blade 38 with respect to the selected substrate 14 to be adjusted. As illustrated in FIG. 4, the bore 71 in the upper surface 47 of the base portion 32 is axially aligned with and meets with the bore 70 at the flange 72. The flange 72 is threaded at an inner peripheral surface such that a fastener 90, such as a bolt, can be inserted through the bore 71 and threadably secured to the flange 72. As a result, the threaded shaft of the fastener 90 extends through the flange 72 and into contact with the magnet 80 positioned within the bore 70. A bore 92 is provided in the hand grip portion 34 such that the bore 92 can be aligned with the bore 71 and a user can insert an adjusting tool, such as a screwdriver, through the aligned bores 92, 71 and into engagement with the fastener 90. By threadably adjusting the fastener 90 within the flange 72, the magnet 80 can be moved within the sleeve member 74 to adjust the length of the blade 38 extending outwardly from the lower surface 78 of the sleeve member 74.

It is contemplated that the blade 38 may be spring-loaded and operatively connected to an actuator configured into the hand grip portion 34. The actuator would be operable to adjust the depth of penetration of the blade 38 and to adjust the spring pressure behind the blade 38 to assist cutting through thicker substrates.

The cutter 18 and the cutter guide 16 are constructed and arranged to enable the substrate cutting operation to be performed by engaging the substrate engaging surface 20 of the cutter guide 16 with the selected substrate 14, penetrating the selected substrate 14 with the cutting blade 38, and then moving the cutter 18 with the projection 56 received in the groove 22 in a closed loop along the groove 22 such that the guidable surface 36 and the guiding surfaces 24, 26 are engaged with one another. The guiding surfaces 24, 26 of the cutter guide 16 and guidable surface 36 of the projection 56 cooperate to guide the cutter 18 so that the cutting edge 68 of the blade 38 cuts the selected substrate 14 along a closed loop cutting path generally similar to the guiding surfaces 24, 26 to cut the substrate portion 12 from the selected substrate 14. The cutter 18 and the cutter guide 16 provide the substrate portion 12 with a peripheral geometric shape determined by the cutting path and thus similar to the endless guiding surfaces 24, 26. Thus, the substrate portion 12, as illustrated in FIG. 1, will be rectangular in shape.

During the cutting operation, it is preferable that the user's hand and resulting downward pressure therefrom be directed normal to the cutter guide 16. This tends to create sufficient friction between the substrate engaging surface 20 of the cutter guide 16 and the selected substrate 14 such that the possibility of the cutter guide 16 moving relative to the selected substrate 14 during a cutting operation is substantially reduced.

It should be noted that the system 10 illustrated is adapted to cut radiused comers when the desired substrate portion 12 is generally rectangular in shape. The size of the radius of the comer can be adjusted in order to create a very small radius (a sharp comer) or a very large radius (a generally circular comer).

Specifically, if the cutting path of the blade 38 is positioned such that it passes through a centerpoint of a circle that makes up a radius of a comer of the endless groove 22, a very small radiused comer (or sharp comer) can be cut by the cutter 18. If the cutting path of the blade 38 is positioned such that it passes through a point radially inwardly of the centerpoint of the circle that makes up the radius of the comer of the endless groove 22, a larger radiused or more circular comer can be cut by the cutter 18.

Preferably, the guiding surfaces 24, 26 are endless and thus the cutting path is a completely closed loop. However, many of the features of the present invention may be practiced with a guide wherein a structure in the groove 22 separates two terminal ends of the cutting path. The ends of the cutting path, however, should be closely adjacent to one another so that the cutting path is as near as a closed loop as possible. Less preferably, the cutting path could be segmented by a number of structures in the groove 22.

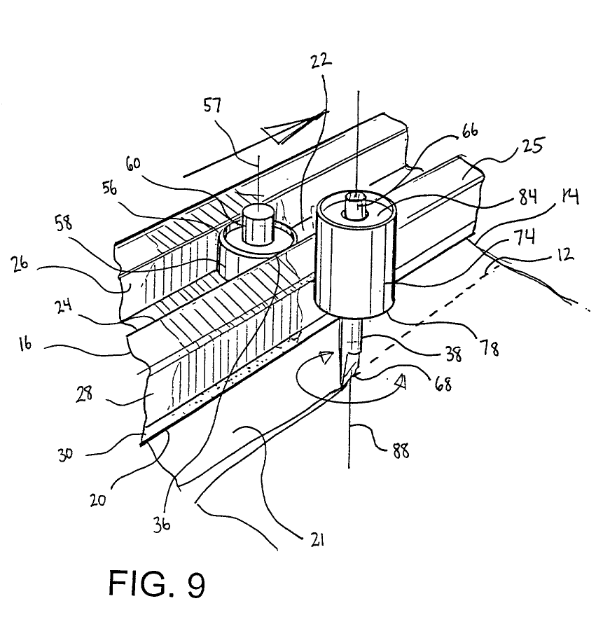

As illustrated in FIGS. 4 and 9, the sleeve member 74 and the projection 56 straddle an inner wall 25 of the cutter guide 16, the inner wall 25 defining the guiding surface 24. The cutter 18 may be guided by the engagement of the guiding surface 24 and the guidable surface 36 of the projection 56 alone, as the straddling installation is sufficient to maintain the cutter 18 on the cutter guide 16 and provide the cutting path. However, the use of the groove 22 with two guiding surfaces 24, 26 is preferred for a few reasons. First, the presence of the groove 22 makes insertion of the projection 56 an intuitive movement. Second, the use of two surfaces 24, 26 tends to keep the cutter 18 better aligned on the cutting path with minimal movement perpendicular to the cutting path. The projection 56 and the groove 22 are also relatively easy to manufacture.

Because the groove 22 provides for easy receipt of the projection 56, this design facilitates using the cutter 18 with guides 16 of varying sizes and shapes. For example, a single cutter 18 may be sold in a package with guides 16 of varying sizes and shapes, such as oval, rectangle, circle, and triangle.

The hand grip portion 34 is rotatably mounted on the base portion 32 to allow a user's hand to remain in generally the same orientation with respect to the selected substrate 14 as a change in direction of movement of the cutter 18 occurs during movement of the cutter 18 to cut the substrate 14 as aforesaid.

The cutting blade 38 is rotatably mounted on the base portion 32 so that the cutting edge 68 of the blade 38 remains generally aligned along the cutting path as the change in direction of movement of the cutter 18 occurs during movement of the cutter 18 with the guidable surface 36 and the guiding surfaces 24, 26 engaged with one another as aforesaid.

The rotatably mounted blade 38 is particularly advantageous when cutting corners of the selected substrate 14. A rigidly mounted blade makes an abrupt change of direction at comers, which results in rips at the comers. The rotatably mounted blade 38 of the present invention stays properly oriented and aligned along the cutting path when cutting corners. Specifically, because the blade 38 tapers toward the cutting edge 68, the movement of the blade 38 through the selected substrate 14 will tend to cause the blade 38 to stay oriented with its cutting edge 68 aligned properly in the cutting direction. This enables the blade 38 to gradually rotate around the corner without ripping the same. The rotatably mounted blade 38 also enables the user to easily move the cutter 18 in both clockwise and counterclockwise directions about the cutter guide 16, as the blade 38 can rotatably self-align itself.

The system 10 may further comprise a base member 94, also referred to as a cutting pad. During cutting, the selected substrate 14 is placed on an upper surface 98 of the base member 94. The base member 94 protects the table or desktop on which the cutting operation is being performed. The upper surface 98 of the base member 94 is designed to inhibit relative movement between the base member 94 and a lower surface 96 of the selected substrate 14. Specifically, the upper surface 98 is provided by an anti-slip material that tends to prevent the selected substrate 14 from slipping thereon during cutting. The anti-slip surface 98 may be provided as a thin layer of anti-slip material secured to a body of the base member 94 or the base member 94 may be constructed entirely of the anti-slip material. The anti-slip material may be in the form of neoprene, or any other material with a suitably high coefficient of friction that tends to prevent the selected substrate 14 from moving relative to the base member 94. It is preferable that the base member 94 is self-healing such that gashes or cuts that the base member 94 receives during a cutting operation close themselves and do not influence subsequent cutting operations.

The lower surface 99 of the base member 94 may be provided by an anti-slip material designed to inhibit relative movement between the base member 94 and a surface 100 of a support structure 102, such as a desk or table. Similar to the above, the anti-slip surface 99 may be provided as a thin layer of anti-slip material secured to the body of the base member 94 or the base member 94 may be constructed entirely of the anti-slip material.

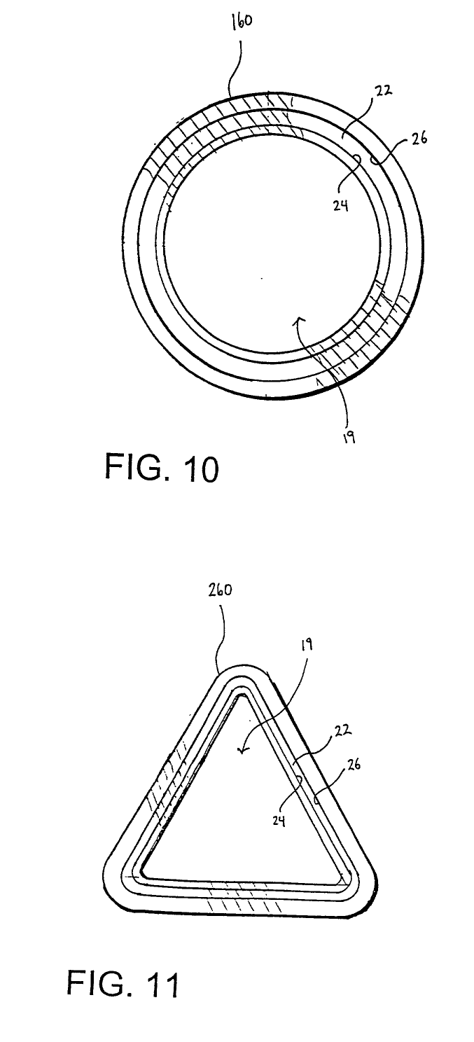

The cutter 18 can be easily removed and installed on different size or shape cutter guides 16. For example, the cutter guide may be in the form of a circle, as shown in FIG. 10 and indicated at 160, or a triangle, as shown in FIG. 11 and indicated at 260. Similar reference numerals are used to indicate the endless groove 22 and the guiding surfaces 24, 26 in the cutter guides 160, 260.

The cutter 18 may further comprise a protective cover for the blade 38 in order to protect the user from cutting themselves. The cover may be removably mountable to the base portion 32 in covering relation to the blade 38, which would require the user to remove and replace the cover before and after a cutting operation, respectively. The cover may also be in the form of an automatically retractable cover wherein the cover would retract from covering relation as well as extend into covering relation with respect to the blade 38 automatically. For example, installing the cutter 18 on the cutter guide 16 would automatically retract the cover to expose the blade 38 for a cutting operation. Likewise, removing the cutter 18 from the cutter guide 16 would cause a spring to automatically extend the cover to cover the blade 38 in order to protect the user.

The blade 38 may be replaced with a generally cylindrical blade having an annular cutting edge, similar to a pizza cutter. The cylindrical blade would provide a smooth rolling cut and would also permit a user to apply a substantial amount of pressure to the hand grip portion 34 without causing the cylindrical blade to dig into the base member 94. The cylindrical cutter would be particularly effective for cutting thicker substrates and for cutting rounded comers. However, the blade 38 is preferable because it is more suitable for sharp comer cutting.

It should be noted that the substrate cutting system 10 may be used to cut selected portions from a variety of items. In addition to paper having a digital photograph printed thereon, the cutting system 10 may be used to cut selected portions from magazines and cardboard items for example.

It should also be noted that the rotatably mounted and adjustable blade 38, the rotatably mounted hand grip portion 34, and the use of anti-slip material on both the cutter guide 16 and the base member 94 can be incorporated into any cutting system, such as the cutting systems disclosed in British Patent Publication Nos. 14,836 and 20,694. The disclosures of these British Patent Publication Nos. 14,836 and 20,694 are hereby incorporated by reference into the present specification.

An advantage of the present invention is that the rotatably mounted blade 38 allows for clean and smooth comer cutting. Removably mounting the blade 38 using the magnet 80 also facilitates removal and replacement of the blade 38.

Another advantage of the present invention is the use of the hand grip portion 34 that rotates relative to the base portion 32 during cutting. The rotatably mounted hand grip portion 34 allows the user to maintain generally the same hand orientation during cutting.

Still another advantage of the present invention is the use of the cutter guide 16 having the endless groove 22 and the cutter 18 that has the projection 56, in the form of the ball bearing 58, receivable in the groove 22 to locate the cutter 18. This structure facilitates installation of the cutter 18 on the cutter guide 16 and allows different size or shape cutter guides 16 to be easily utilized. This structure also facilitates movement of the cutter 18, particularly around comers, during a cutting operation.

Still another advantage of the present invention is the use of anti-slip material on both the cutter guide 16 and the base member 94. The anti-slip material prevents relative movement between the paper and the cutter guide 16, the paper and the base member 94, and the base member 94 and the support structure 102.

It can thus be appreciated that the objectives of the present invention have been fully and effectively accomplished. The foregoing specific embodiments have been provided to illustrate the structural and functional principles of the present invention and are not intended to be limiting. To the contrary, the present invention is intended to encompass all modifications, alterations, and substitutions within the spirit and scope of the appended claims.

What is claimed is

1. A substrate cutting system for performing a substrate cutting operation wherein a substrate portion is cut from a selected substrate, said system comprising:
a cutter guide having a substrate engaging surface engageable with the selected substrate and a guiding surface; and
a substrate cutter comprising:
(a) a base portion,
(b) a manually engageable hand grip portion configured to be manually grasped,
(c) a guidable surface provided on said base portion and engageable with said guiding surface of said cutter guide, and
(d) a substrate cutting blade configured to penetrate the selected substrate such that movement of said blade when penetrated cuts through the selected substrate;
said cutter and said cutter guide being constructed and arranged to enable the substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter with said guidable and guiding surfaces engaged with one another as aforesaid.

2. A substrate cutting system according to claim 1, wherein said cutter guide has a fixed shape.

3. A substrate cutting system according to claim 1, wherein said substrate engaging surface and said guiding surface of said cutter guide are generally perpendicular to one another.

4. A substrate cutting system according to claim 1, wherein said hand grip portion and said base portion are each molded from plastic.

5. A substrate cutting system according to claim 1, wherein said cutter guide is molded from plastic.

6. A substrate cutting system according to claim 1, wherein said cutter guide has an endless groove formed therein which provides an opposed pair of said guiding surfaces each of which are endless, said cutter further comprising a guide structure extending from said base portion, said guide structure being receivable in said groove of said cutter guide between said endless guiding surfaces such that said guiding surfaces engage opposing sides of said guide structure and cooperate with said guide structure to guide said cutter during movement thereof to cut the selected substrate.

7. A substrate cutting system according to claim 6, wherein said guide structure comprises a single projection receivable in said groove.

8. A substrate cutting system according to claim 1, wherein said cutter guide has a body formed of a first material and a substrate engaging portion formed of a second material and providing said substrate engaging surface, so as to inhibit slippage between said selected substrate and said substrate engaging surface.

9. A substrate cutting system according to claim 1, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter with said guidable and guiding surfaces engaged with one another as aforesaid.

10. A substrate cutting system according to claim 1, further comprising a base member, said base member having an upwardly facing anti-slip surface on which said selected substrate is placed during the cutting operation to inhibit relative movement between said base member and said selected substrate.

11. A substrate cutting system according to claim 9, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

12. A substrate cutting system according to claim 11, wherein the magnet is adjustable within the bore so as to axially adjust the blade engaged therewith with respect to the base portion.

13. A substrate cutter for use with a cutter guide having a substrate engaging surface engageable with a selected substrate and a guiding surface, said cutter comprising:
(a) a base portion,
(b) a manually engageable hand grip portion configured to be manually grasped,
(c) a guidable surface provided on said base portion and engageable with said guiding surface of said cutter guide, and
(d) a substrate cutting blade configured to penetrate the selected substrate such that movement of said blade when penetrated cuts through the selected substrate;
said cutter being constructed and arranged to enable a substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter with said guidable and guiding surfaces engaged with one another as aforesaid.

14. A substrate cutter according to claim 13, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter with said guidable and guiding surfaces engaged with one another as aforesaid.

15. A substrate cutter according to claim 13, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

16. A substrate cutter according to claim 15, wherein the magnet is adjustable within the bore so as to axially adjust the blade engaged therewith with respect to the base portion.

17. A substrate cutting system for performing a substrate cutting operation wherein a substrate portion is cut from a selected substrate, said system comprising:
a cutter guide having a substrate engaging surface engageable with the selected substrate and a groove providing an opposed pair of guiding surfaces on an interior thereof; and
a substrate cutter comprising:
(a) a base portion,
(b) a guide structure extending from said base portion, said guide structure being receivable in said groove of said cutter guide between said guiding surfaces with said guiding surfaces on opposing sides of said guide structure, and
(c) a substrate cutting blade configured to penetrate the selected substrate such that movement of said blade when penetrated cuts through the selected substrate;
said cutter and said cutter guide being constructed and arranged to enable the substrate cutting operation to be performed by engaging said substrate engaging surface of said cutter guide with the selected substrate, penetrating the selected substrate with said cutting blade, and then moving said cutter with said guide structure received in said groove such that said guiding surfaces and said guide structure cooperate to guide said cutter so that said blade cuts the selected substrate along a cutting path generally similar to said guiding surfaces to cut the substrate portion from the selected substrate and provide the substrate portion with a peripheral geometric shape determined by said cutting path and thus similar to said guiding surfaces.

18. A substrate cutting system according to claim 17, wherein said guiding surfaces of said groove are endless such that said cutting path is a closed loop.

19. A substrate cutting system according to claim 17, wherein said guide structure comprises a single projection receivable in said groove.

20. A substrate cutting system according to claim 17, wherein said cutter guide has a fixed shape.

21. A substrate cutting system according to claim 17, wherein said guiding surfaces are parallel to one another and wherein said substrate engaging surface is generally perpendicular to said guiding surfaces.

22. A substrate cutting system according to claim 17, wherein said base portion of said cutter is molded from plastic.

23. A substrate cutting system according to claim 17, wherein said cutter guide is molded from plastic.

24. A substrate cutting system according to claim 17, wherein said cutter guide has a body formed of a first material and a substrate engaging portion formed of a second material and providing said substrate engaging surface, so as to inhibit slippage between said selected substrate and said substrate engaging surface.

25. A substrate cutting system according to claim 17, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter to cut the selected substrate as aforesaid.

26. A substrate cutting system according to claim 17, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

27. A substrate cutting system according to claim 17, further comprising a base member, said base member having an upwardly facing anti-slip surface on which said selected substrate is placed during the cutting operation to inhibit relative movement between said base member and said selected substrate.

28. A substrate cutting system according to claim 25, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

29. A substrate cutting system according to claim 28, wherein the magnet is adjustable within the bore so as to axially adjust the blade engaged therewith with respect to the base portion.

30. A substrate cutting system according to claim 18, wherein said cutter guide has a fixed shape.

31. A substrate cutting system according to claim 30, wherein said guiding surfaces are parallel to one another and wherein said substrate engaging surface is generally perpendicular to said guiding surfaces.

32. A substrate cutting system according to claim 31, wherein said cutter guide is molded from plastic.

33. A substrate cutting system according to claim 32, wherein said base portion of said cutter is molded from plastic.

34. A substrate cutting system according to claim 33, wherein said guide structure comprises a single projection receivable in said groove.

35. A substrate cutting system for performing a substrate cutting operation wherein a substrate portion is cut from a selected substrate, said system comprising:
a cutter guide having a substrate engaging surface engageable with the selected substrate and a guiding surface; and
a substrate cutter comprising:
(a) a base portion,
(b) a guidable surface provided on said base portion and engageable with said guiding surface of said cutter guide, and
(c) a substrate cutting blade having a cutting edge, said blade being configured to penetrate the selected substrate such that said cutting edge of said blade when penetrated cuts through the selected substrate as said cutter is moved;
said cutter and said cutter guide being constructed and arranged to enable the substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said cutting blade being rotatably mounted on said base portion such that blade rotates relative to said base portion so that said cutting edge of said blade remains generally aligned along said cutting path as a change in direction of movement of said cutter occurs during movement of said cutter with said guidable and guiding surfaces engaged with one another as aforesaid.

36. A substrate cutting system according to claim 35, wherein said cutter guide has a fixed shape.

37. A substrate cutting system according to claim 35, wherein said substrate engaging surface and said guiding surface of said cutter guide are generally perpendicular to one another.

38. A substrate cutting system according to claim 35, wherein said hand grip portion and said base portion are each molded from plastic.

39. A substrate cutting system according to claim 35, wherein said cutter guide is molded from plastic.

40. A substrate cutting system according to claim 35, wherein said cutter guide has an endless groove formed therein which provides an opposed pair of said guiding surfaces each of which are endless, said cutter further comprising a guide structure extending from said base portion, said guide structure being receivable in said groove of said cutter guide between said endless guiding surfaces such that said guiding surfaces engage opposing sides of said guide structure and cooperate with said guide structure to guide said cutter during movement thereof to cut the selected substrate.

41. A substrate cutting system according to claim 40, wherein said guide structure comprises a single projection receivable in said groove.

42. A substrate cutting system according to claim 35, wherein said cutter guide has a body formed of a first material and a substrate engaging portion formed of a second material and providing said substrate engaging surface, so as to inhibit slippage between said selected substrate and said substrate engaging surface.

43. A substrate cutting system according to claim 35, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

44. A substrate cutting system according to claim 35, further comprising a base member, said base member having an upwardly facing anti-slip surface on which said selected substrate is placed during the cutting operation to inhibit relative movement between said base member and said selected substrate.

45. A substrate cutting system according to claim 35, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

46. A substrate cutting system according to claim 45, wherein the magnet is adjustable within the bore so as to axially adjust the blade engaged therewith with respect to the base portion.

47. A substrate cutter for use with a cutter guide having a substrate engaging surface engageable with a selected substrate and a guiding surface, said cutter comprising:
(a) a base portion,
(b) a guidable surface provided on said base portion and engageable with said guiding surface of said cutter guide, and
(c) a substrate cutting blade having a cutting edge, said blade being configured to penetrate the selected substrate such that said cutting edge of said blade when penetrated cuts through the selected substrate as said cutter is moved;
said cutter being constructed and arranged to enable a substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said cutting blade being rotatably mounted on said base portion such that said blade rotates relative to said base portion so that said cutting edge of said blade remains generally aligned along said cutting path as a change in direction of movement of said cutter occurs during movement of said cutter with said guidable and guiding surfaces engaged with one another as aforesaid.

48. A substrate cutter according to claim 47, wherein said hand grip portion and said base portion are each molded from plastic.

49. A substrate cutter according to claim 47, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

50. A substrate cutter according to claim 47, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

51. A substrate cutter according to claim 50, wherein the magnet is adjustable within the bore so as to axially adjust the blade engaged therewith with respect to the base portion.

52. A substrate cutting system for performing a substrate cutting operation wherein a substrate portion is cut from a selected substrate, said system comprising:
a cutter guide including a body formed from a first material and providing a guiding surface, said cutter guide further including a substrate engaging portion formed from a second material and providing a substrate engaging surface engageable with the selected substrate, said second material having a substantially higher coefficient of friction than said first material so as to inhibit slippage between said selected substrate and said substrate engaging surface; and
a substrate cutter comprising:
(a) a base portion,
(b) a guidable surface provided on said base portion and engageable with said guiding surface of said cutter guide, and
(c) a substrate cutting blade configured to penetrate the selected substrate such that said blade when penetrated cuts through the selected substrate as said cutter is moved;
said cutter and said cutter guide being constructed and arranged to enable the substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface.

53. A substrate cutting system according to claim 52, wherein said cutter guide has a fixed shape.

54. A substrate cutting system according to claim 52, wherein said substrate engaging surface and said guiding surface of said cutter guide are generally perpendicular to one another.

55. A substrate cutting system according to claim 52, wherein said hand grip portion and said base portion are each molded from plastic.

56. A substrate cutting system according to claim 52, wherein said cutter guide is molded from plastic.

57. A substrate cutting system according to claim 52, wherein said cutter guide has an endless groove formed therein which provides an opposed pair of said guiding surfaces each of which are endless, said cutter further comprising a guide structure extending from said base portion, said guide structure being receivable in said groove of said cutter guide between said endless guiding surfaces such that said guiding surfaces engage opposing sides of said guide structure and cooperate with said guide structure to guide said cutter during movement thereof to cut the selected substrate.

58. A substrate cutting system according to claim 57, wherein said guide structure comprises a single projection receivable in said groove.

59. A substrate cutting system according to claim 52, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter with said guidable and guiding surfaces engaged with one another as aforesaid.

60. A substrate cutting system according to claim 52, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

61. A substrate cutting system according to claim 52, further comprising a base member, said base member having an upwardly facing anti-slip surface on which said selected substrate is placed during the cutting operation to inhibit relative movement between said base member and said selected substrate.

62. A substrate cutting system according to claim 59, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

63. A substrate cutting system according to claim 62, wherein the magnet is adjustable within the bore so as to axially adjust the blade engaged therewith with respect to the base portion.

64. A cutter guide for use with a substrate cutter having a base portion, a guide structure extending from the base portion, and a substrate cutting blade, said cutter guide comprising:
a substrate engaging surface engageable with a selected substrate; and
a groove providing an opposed pair of guiding surfaces on an interior thereof, said groove being configured to receive said guide structure therein between said guiding surfaces with said guiding surfaces on opposing sides of said guide structure,
said cutter guide being constructed and arranged to enable a substrate cutting operation to be performed by engaging said substrate engaging surface of said cutter guide with the selected substrate, penetrating the selected substrate with said cutting blade, and then moving said cutter with said guide structure received in said groove along said groove such that said guiding surfaces and said guide structure cooperate to guide said cutter so that said blade cuts the selected substrate along a cutting path generally similar to said guiding surfaces to cut the substrate portion from the selected substrate and provide the substrate portion with a peripheral geometric shape determined by said cutting path and thus similar to said guiding surfaces.

65. A cutter guide according to claim 64, wherein said guide surfaces are endless such that said cutting path is a closed loop.

66. A cutter guide according to claim 64, wherein said cutter guide has a fixed shape.

67. A cutter guide according to claim 64, wherein said guiding surfaces are parallel to one another and wherein said substrate engaging surface is generally perpendicular to said guiding surfaces.

68. A cutter guide according to claim 64, wherein said cutter guide is molded from plastic.

69. A cutter guide according to claim 64, wherein said cutter guide has a body formed of a first material and a substrate engaging portion formed of a second material and providing said substrate engaging surface, so as to inhibit slippage between said selected substrate and said substrate engaging surface.

70. A cutter guide according to claim 65, wherein said cutter guide has a fixed shape.

71. A cutter guide according to claim 70, wherein said guiding surfaces are parallel to one another and wherein said substrate engaging surface is generally perpendicular to said guiding surfaces.

72. A cutter guide according to claim 71, wherein said cutter guide is molded from plastic.

73. A cutter guide for use with a substrate cutter having a base portion, a guidable surface provided on the base portion, and a substrate cutting blade, said cutter guide comprising:
a body formed from a first material and providing a guiding surface engageable with said guidable surface; and
a substrate engaging portion formed from a second material and providing a substrate engaging surface engageable with a selected substrate, said second material having a substantially higher coefficient of friction than said first material so as to inhibit slippage between said selected substrate and said substrate engaging surface,
said cutter guide being constructed and arranged to enable a substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface.

74. A cutter guide according to claim 73, wherein said cutter guide has a fixed shape.

75. A cutter guide according to claim 73, wherein said substrate engaging surface and said guiding surface of said cutter guide are generally perpendicular to one another.

76. A cutter guide according to claim 73, wherein said cutter guide is molded from plastic.

77. A cutter guide according to claim 73, wherein said cutter guide has an endless groove formed therein which provides an opposed pair of said guiding surfaces each of which are endless, said cutter further comprising a guide structure extending from said base portion, said guide structure being receivable in said groove of said cutter guide between said endless guiding surfaces such that said guiding surfaces engage opposing sides of said guide structure and cooperate with said guide structure to guide said cutter during movement thereof to cut the selected substrate.

78. A cutter guide according to claim 77, wherein said guide structure comprises a single projection receivable in said groove.

79. A substrate cutting system for performing a substrate cutting operation wherein a substrate portion is cut from a selected substrate, said system comprising:
a cutter guide having a substrate engaging surface engageable with the selected substrate and a guiding surface; and
a substrate cutter comprising:
(a) a base portion,
(b) a manually engageable hand grip portion configured to be manually grasped,
(c) a guidable surface provided on said base portion and engageable with said guiding surface of said cutter guide, and
(d) a substrate cutting blade configured to penetrate the selected substrate such that movement of said blade when penetrated cuts through the selected substrate;
said cutter and said cutter guide being constructed and arranged to enable the substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said blade being adjustable in a depth setting direction relative to said base portion so as to enable a depth of penetration of said blade with respect to the selected substrate to be adjusted.

80. A substrate cutting system according to claim 79, wherein said cutter guide has a fixed shape.

81. A substrate cutting system according to claim 79, wherein said substrate engaging surface and said guiding surface of said cutter guide are generally perpendicular to one another.

82. A substrate cutting system according to claim 79, wherein said hand grip portion and said base portion are each molded from plastic.

83. A substrate cutting system according to claim 79, wherein said cutter guide is molded from plastic.

84. A substrate cutting system according to claim 79, wherein said cutter guide has an endless groove formed therein which provides an opposed pair of said guiding surfaces each of which are endless, said cutter further comprising a guide structure extending from said base portion, said guide structure being receivable in said groove of said cutter guide between said endless guiding surfaces such that said guiding surfaces engage opposing sides of said guide structure and cooperate with said guide structure to guide said cutter during movement thereof to cut the selected substrate.

85. A substrate cutting system according to claim 84, wherein said guide structure comprises a single projection receivable in said groove.

86. A substrate cutting system according to claim 79, wherein said cutter guide has a body formed of a first material and a substrate engaging portion formed of a second material and providing said substrate engaging surface, so as to inhibit slippage between said selected substrate and said substrate engaging surface.

87. A substrate cutting system according to claim 79, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter with said guidable and guiding surfaces engaged with one another as aforesaid.

88. A substrate cutting system according to claim 79, further comprising a base member, said base member having an upwardly facing anti-slip surface on which said selected substrate is placed during the cutting operation to inhibit relative movement between said base member and said selected substrate.

89. A substrate cutting system according to claim 79, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

90. A substrate cutting system according to claim 87, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

91. A substrate cutting system according to claim 90, wherein the magnet is adjustable within the bore so as to axially adjust the blade engaged therewith with respect to the base portion.

92. A substrate cutter for use with a cutter guide having a substrate engaging surface engageable with a selected substrate and a guiding surface, said cutter comprising:
(a) a base portion,
(b) a manually engageable hand grip portion configured to be manually grasped,
(c) a guidable surface provided on said base portion and engageable with said guiding surface of said cutter guide, and
(d) a substrate cutting blade configured to penetrate the selected substrate such that movement of said blade when penetrated cuts through the selected substrate;
said cutter and said cutter guide being constructed and arranged to enable a substrate cutting operation to be performed by engaging said substrate engaging surface of said cutter guide with the selected substrate, penetrating the selected substrate with said cutting blade, and then moving said cutter with said guidable and guiding surfaces engaged with one another such that said guiding and guidable surfaces cooperate to guide said cutter so that said cutting edge of said blade cuts the selected substrate along a cutting path generally similar to said guiding surface to cut the substrate portion from the selected substrate and provide the substrate portion with a peripheral geometric shape determined by said cutting path and thus similar to said guiding surface,
said blade being adjustable in a depth setting direction relative to said base portion so as to enable a depth of penetration of said blade with respect to the selected substrate to be adjusted.

93. A substrate cutter according to claim 92, wherein said blade has a cutting edge and said blade is configured to penetrate the selected substrate such that said cutting edge of said blade when penetrated cuts through the selected substrate as said cutter is moved, said cutting blade being rotatably mounted on said base portion such that blade rotates relative to said base portion so that said cutting edge of said blade remains generally aligned along said cutting path as the change in direction of movement of said cutter occurs during movement of said cutter with said guidable and guiding surfaces engaged with one another as aforesaid.

94. A substrate cutting system according to claim 92, wherein said substrate cutter further comprises a hand grip portion configured to be manually grasped, said hand grip portion being rotatably mounted on said base portion such that said base portion rotates relative to said hand grip portion so as to allow a user's hand to remain in generally the same orientation with respect to the selected substrate as a change in direction of movement of said cutter occurs during movement of said cutter to cut the substrate as aforesaid.

95. A substrate cutter according to claim 93, wherein said base portion includes a magnet and at least one ball bearing securely positioned within a bore of said base portion, the blade axially extending through the ball bearing and engaging with the magnet such that the blade is prevented from axial movement with respect to the base portion and is permitted to rotate about an axis.

96. A substrate cutter according to claim 95, wherein the magnet is adjustable within the bore so as to axially adjust the blade engaged therewith with respect to the base portion.
